(19) United States
(12) Patent Application Publication
(10) Pub. No.: US 2015/0086326 A1
(43) Pub. Date: Mar. 26, 2015

(54) METHOD FOR OPTIMIZING PERFORMANCE OF A COMPRESSOR USING INLET GUIDE VANES AND DRIVE SPEED AND IMPLEMENTATION THEREOF

(71) Applicant: Dresser, lnc., Addison, TX (US)

(72) Inventors: Dale Eugene Husted, Centerville, IN (US); Marc Gavin Lindenmuth, Atlanta, GA (US)

(21) Appl. No.: 14/556,585

(22) Filed: Dec. 1, 2014

Related U.S. Application Data
(63) Continuation-in-part of application No. 13/601,862, filed on Aug. 31, 2012.
(60) Provisional application No. 62/004,236, filed on May 29, 2014.

(51) Int. Cl. F04D 27/02; G05B 13/02; G05D 7/06; F04D 17/10

(52) U.S. Cl. CPC F04D 27/0246; F04D 27/0261; F04D 17/10; G05B 13/0205; G05D 7/0617
USPC 415/1; 415/14; 700/283

(57) ABSTRACT

A method for optimizing performance of a compressor by adjusting the position of an inlet guide vane and the speed of a drive unit. In one embodiment, the method can compare measured values for operating flow rate and operating pressure for a combination of operating settings for the position and the speed against threshold values for each of these measured values. In this way, the method can identify “how” the compressor is operating and equate such operation to one of a plurality of operation scenarios. In turn, the method can provide an adjustment to one or both of the speed and the position that corresponds with such operating scenario. The method can also vet the selected adjustment to avoid operation of the compressor outside of its safe operating configurations, as defined for example by minimum and maximum values for the position of the inlet guide vane and the speed of the drive unit.

### CROSS-REFERENCE TO RELATED APPLICATIONS

This application claims the benefit of priority to U.S. Provisional Application Ser. No. 62/004,236, filed on May 29, 2014, and entitled “DEVICES, SYSTEMS, AND METHODS FOR CONTROLLING COMPRESSOR.” This application is a continuation-in-part of U.S. patent application Ser. No. 13/601,862, filed on Aug. 31, 2012, and entitled “SYSTEM AND METHOD FOR OPERATING A COMPRESSOR DEVICE.”

### BACKGROUND

The subject matter disclosed herein relates to compressors and related machinery, with particular discussion about a method for optimizing performance of a compressor that has a variable speed drive and one or more variable inlet guide vanes.

Factory owners and operators strive to reduce operating costs. These efforts benefit from improvements in operating efficiencies, namely, to reduce power consumption of any equipment that are deployed within the factory and/or industrial setting. This equipment often includes compressors. As used herein, the term “compressor” describes machinery that acts on a working fluid, for example, to pressurize the working fluid to distribute on a process line. This machinery can include, for example, compressors (e.g., centrifugal compressors) and blowers, with artisans understanding that the difference between the two resides in the operating pressures of the fluid at the discharge. Examples of process lines may be found in various applications including chemical, water-treatment, petro-chemical, resource recovery and delivery, refinery, and like sectors and industries.

Compressors typically include a drive unit that is configured to rotate an impeller. Centrifugal compressors, for example, are a type of compressor that includes an impeller with vanes having an increasing radius. During operation, the impeller draws fluid into the compressor. Examples of the drive unit include steam turbines, gas turbines, and electric motors. Compressors may also include vanes (also “inlet guide vanes”) that are configured to move (e.g., rotate) to increase or decrease the effective size, or flow area, of the inlet to the compressor. The effective size of the effective flow area, in turn, regulates the flow rate of the working fluid.

Among the difficulties to optimize operation and minimize power consumption of compressors is that gains in operating efficiency typically depend on both the setpoints (e.g., flow rate, pressure, etc.) required by the process and the operating settings (e.g., max/min speed for the drive unit, max/min position of guide vane position, etc.) for the compressor. For example, certain combinations of position of the inlet guide vanes and speed of the drive unit may result in flow that meets desired setpoints and consumes less power. These same combinations, however, might damage the compressor because the position of the inlet guide vanes and/or the speed of the drive unit may reside at or near or outside certain safe and acceptable levels for these operating settings.

Conventional control systems can leverage the variability in the position of the inlet guide vanes and the speed of the drive unit to improve performance, efficiency, and reduce cost of operation by reducing power consumption. Unfortunately, the process to optimize performance of compressors with variable components often requires extensive testing and qualification. This process can be labor and time intensive and, moreover, must often be performed on the compressor at the time of installation. As a result, it is conventional practice to manually optimize efficiency by adjusting inlet guide vanes only while holding speed constant. Such practice, however, likely does not consider the myriad combinations of speed and inlet guide vane orientation that can influence the level of efficiency attached by the compressor. Thus, while efficiency improvement can be seen by adjusting inlet guide vanes only for a given speed, the conventional practice of adjusting only a single parameter may not reach the true and optimal efficiency because only the angle of the inlet guide vane angle with respect to the flow of the working fluid is used to modify operation of the compressor.

### BRIEF DESCRIPTION OF THE INVENTION

This disclosure describes improvements that reduce the time and effort necessary to qualify compressors with variable inlet guide vanes and variable speed drives for use in the field. The embodiments herein can automatically arrive at operating settings that achieve lower (and/or minimize) the amount of power required to operate the compressor at the setpoints desired. As noted more below, these embodiments can compare measured values for operating flow rate and operating pressure for a combination of operating settings against threshold values for each of these measured values. The embodiments leverage this comparison to identify “how” the compressor is operating, equating the operation of the compressor to one of a plurality of operation scenarios. In turn, the embodiments provide an adjustment to one or both of the speed and the position that corresponds with such operating scenario. The embodiments can also vet the selected adjustment to avoid operation of the compressor outside of its safe operating configurations, as defined for example by minimum and maximum values for the position of the inlet guide vane and the speed of the drive unit.

### BRIEF DESCRIPTION OF THE DRAWINGS

Reference is now made briefly to the accompanying drawings, in which:

FIG. 1 depicts a flow diagram for an exemplary embodiment of a method for optimizing performance of a compressor;

FIG. 2 depicts a flow diagram of an exemplary embodiment of the method of FIG. 1 that includes steps for modifying operation of the compressor under a first operating scenario;

FIG. 3 depicts a flow diagram of an exemplary embodiment of the method of FIG. 1 that includes steps for modifying operation of the compressor under a second operating scenario;

FIG. 4 depicts a flow diagram of an exemplary embodiment of the method of FIG. 1 that includes steps for modifying operation of the compressor under a third operating scenario;

FIG. 5 depicts a flow diagram of an exemplary embodiment of the method of FIG. 1 that includes steps for modifying operation of the compressor under a fourth operating scenario;

FIG. 6 depicts a flow diagram of an exemplary embodiment of the method of FIG. 1 with exemplary steps to iterate among the plurality of operating scenarios.

FIG. 7 depicts a perspective view of an exemplary embodiment of a compressor that are configured for to vary in response to performance of the compressor;

FIG. 8 depicts a front view of the compressor of FIG. 7 with a first configuration of an inlet guide vane assembly;

FIG. 9 depicts a front view of the compressor of FIG. 7 with a second configuration of an inlet guide vane assembly; and

FIG. 10 depicts a schematic diagram of a compressor as part of a control system that can operate the compressor in response to feedback about the flow parameters.

Where applicable like reference characters designate identical or corresponding components and units throughout the several views, which are not to scale unless otherwise indicated. Moreover, the embodiments disclosed herein may include elements that appear in one or more of the several views or in combinations of the several views.

### DETAILED DISCUSSION

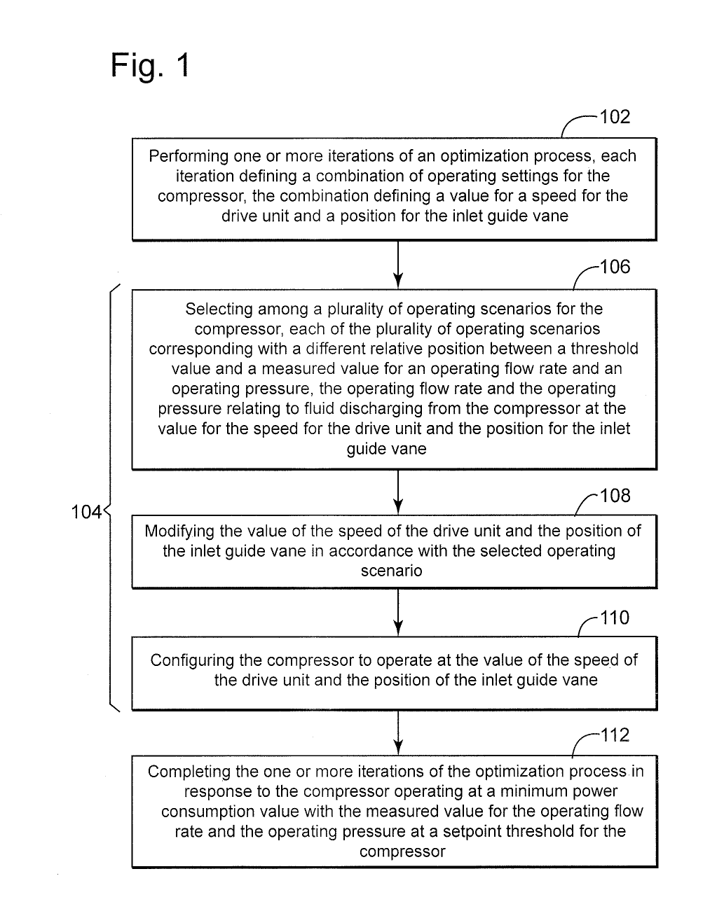

FIG. 1 depicts a flow diagram of an exemplary embodiment of a method 100 that can help reduce power consumption on a compressor. The method 100 includes, at step 102, performing one or more iterations of an optimization process, each iteration defining a combination of operating settings for the compressor, the combination defining a value for a speed for the drive unit and a position for the inlet guide vane. The method 100 also includes, at step 104, executing the optimization process, which includes at step 106, selecting among a plurality of operating scenarios for the compressor, each of the plurality of operating scenarios corresponding with a different relative position between a threshold value and a measured value for an operating flow rate and an operating pressure, the operating flow rate and the operating pressure relating to fluid discharging from the compressor at the value for the speed for the drive unit and the position for the inlet guide vane. The optimization process can also include, at step 108, modifying the value of the speed of the drive unit and the position of the inlet guide vane in accordance with the selected operating scenario and, at step 110, configuring the compressor to operate at the value of the speed of the drive unit and the position of the inlet guide vane. The method 100 can further include, at step 112, completing the one or more iterations of the optimization process in response to the compressor operating at a minimum power consumption value with the measured value for the operating flow rate and the operating pressure at a setpoint threshold for the compressor. In one embodiment, the plurality of operating scenarios maintain the value for the speed of the drive unit and the position of the inlet guide vane at or above a minimum value and at or below a maximum value for the speed of the drive unit and the position of the inlet guide vanes.

The steps of the embodiments of the method 100 can be implemented as one or more executable instructions (e.g., software, firmware, etc.). Such instructions can be deployed on the compressor and/or as part of a control device and/or system. This disclosure provides details of an exemplary structure for a compressor and a control system further below.

In FIG. 1, at step 102, the method 100 implements a control scheme to efficiently iterate through a multitude of operating settings on the compressor. These iterations are useful to arrive at operating settings that configure the compressor to use less power to discharge a flow of working fluid at a setpoint that defines, for example, a flow rate and a pressure desired for the compressor to discharge, e.g., into the process line. The control scheme, in turn, defines specific changes, or adjustments, to the operating settings of the compressor in response to a detected change in flow rate and/or pressure of the discharge flow (collectively, “flow parameters”). For example, the detected change may reflect a change in the flow parameters from a first measured value to a second measured value, wherein each of the first measured value and the second measured value relate to a different set of operating settings, respectively.

The operating settings may correspond to certain components that are configured to modulate flow into and out-of the compressor. In context of the present disclosure, examples of these components on the compressor include the inlet guide vanes (often found as part of an inlet guide vane assembly) and the drive unit (e.g., a motor) that rotates an impeller. This disclosure contemplates, however, that aspects of the embodiments herein may apply to other components (e.g., diffuser vanes) and, more broadly, that other types of machinery may benefit from the improvements in efficiency that are considered herein.

At step 104, the method 100 defines the optimization process that is useful to configure the compressor to consume less power. Examples of the optimization process can include steps for examining the effect that combinations of the speed of the drive unit and the position of the inlet guide vane have on the operation of the compressor. During operation, these combinations may reduce power consumption, but at a cost to performance, e.g., a reduction in operating flow rate and/or drop in operating pressure. The method 100 can remediate the costs to automatically achieve, or balance, power consumption and performance on the compressor. In one aspect, the method 100 is useful to provide a real-time adjustment during operation of the compressor once the compressor is placed in service or installed, e.g., as part of the process line.

At step 106, the method 100 uses the operating scenarios to more clearly direct specific modifications to the operating settings. In the present example, the modifications focus on the speed of the drive unit and the position of the inlet guide vanes. The operating scenarios can include a pressure control and a flow control. The pressure control describes a relationship, or a relative position, between the measured value (Pₘ) and a threshold value (Pₜ) for the operating pressure on the compressor. The flow control, on the other hand, describes a relationship, or relative position, between the measured value (Qₘ) and the threshold value (Qₜ) for the operating flow on the compressor. Each operating scenario defines a unique combination of the pressure control and the flow control. Table 1 below identifies examples of several operating scenarios.

TABLE 1

| Operating Scenario | Pressure Control | Flow Control |
|---|---|---|
| 1 | Pₘ < Pₜ | Qₘ < Qₜ |
| 2 | Pₘ ≧ Pₜ | Qₘ < Qₜ |
| 3 | Pₘ < Pₜ | Qₘ > Qₜ |
| 4 | Pₘ ≧ Pₜ | Qₘ > Qₜ |

The threshold value may embody values that are different from the setpoints for the compressor. For example, the values may include a deadband value (or some other variable) that modifies the setpoints. This deadband value is configured to prevent hysteresis during the optimization process, wherein the modifications in the speed of the drive unit and/or the position of the inlet guide vanes modulate rapidly between particular values. Table 2 below provides examples of threshold values for use as the pressure threshold (Pₜ) and flow threshold (Qₜ) for operating scenarios (including the operating scenarios in Table 1 above) that may occur on the compressor.

TABLE 2

| Operating Scenario | Pressure Threshold | Flow Threshold |
|---|---|---|
| 1 | Pₜ = Pₛ − P_{d1} | Qₜ = Qₛ − Q_{d1} |
| 2 | Pₜ = Pₛ + P_{d2} | Qₜ = Qₛ − Q_{d2} |
| 3 | Pₜ − Pₛ − P_{d3} | Qₜ = Qₛ + Q_{d3} |
| 4 | Pₜ = Pₛ + P_{d4} | Qₜ = Qₛ + Q_{d4} |

As shown in Table 2 above, the deadband values can represent various variables (identified, generally, as P_{di} and Q_{di}). One or more of these values may be the same (e.g., wherein P_{d1}=P_{d2}=P_{d3}=P_{d4} and/or wherein Q_{d1}=Q_{d2}=Q_{d3}=Q_{d4}) or different (e.g., wherein P_{d1}≠P_{d2}≠P_{d3}≠P_{d4} and/or wherein Q_{d1}≠Q_{d2}≠Q_{d3}≠Q_{d4}). The values may also depend on the particular operating scenario. In one example, the deadband value can describe a percentage (e.g., 10%) of the respective setpoint, a fixed value (e.g., 1, 5, etc.), and/or other numeric value that can operate to increase and/or decrease the respective setpoint for use as the threshold value.

The method 100, at step 108, modifies the value of one or more of the speed of the drive unit and the position of the inlet guide vane. For example, the method 100 can increase and/or decrease the speed and/or open or close the inlet guide vane. The amount and/or extent of these changes can depend on the operating scenario (e.g., the operating scenarios 1, 2, 3, and 4 of Tables 1 and 2).

At step 110, the method 100 can implement the new speed and/or new position on the compressor. This step may include one or more steps for generating an output, which may derive from a control and/or circuit that is configured to communication with the respective component on the compressor. In one example, this output can comprise a signal (e.g., an electrical signal) that stimulates an actuator and/or motor, as desired.

At step 112, the method 100 can complete the optimization process. As noted more below, this step may include additional steps for comparing the measured values for the operating flow rate, the operating pressure, and the power to one or more criteria and/or thresholds. This comparison can stop the iterative process, effectively setting the operating settings (e.g., the position of the inlet guide vane and the speed of the drive unit) at values that result in the lowest (or near lowest) power consumption for the compressor.

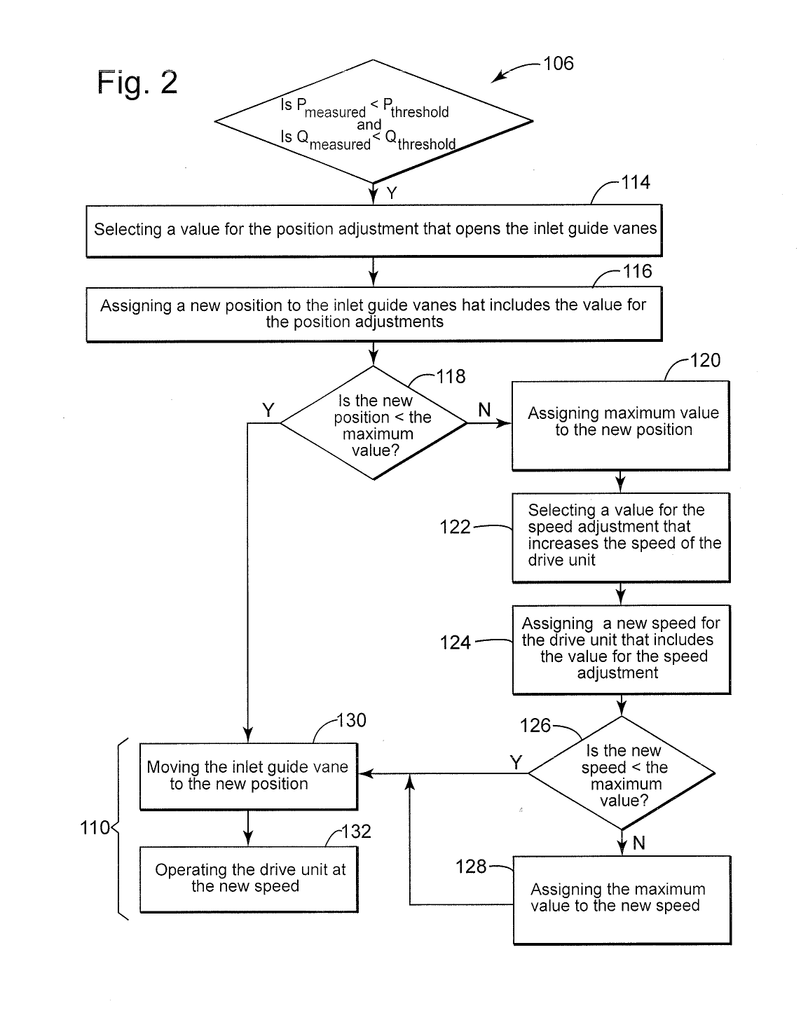

FIGS. 2, 3, 4, and 5 depict a flow diagram for examples for a given operating scenario of the method 100. These examples incorporate steps to modify the operating settings and, thus, effectively minimize power consumption on the compressor. These examples represent several variations that correspond with the operating scenarios outlined in Tables 1 and 2.

In FIG. 2, the example of the method 100 addresses the Operating Scenario 1 in Table 1. In this operating scenario, the measured value for the operating flow rate (Qₘ) and the operating pressure (Pₘ) are less than the threshold value (Pₜ, Qₜ). The method 100 can include, at step 114, selecting a value for the position adjustment that opens the inlet guide vane and, at step 116, assigning a new position to the inlet guide vane that includes the value for the position adjustment. The method 100 also includes, at step 118, comparing the new position to the maximum value for the position of the inlet guide vane. If the new position is equal to (and/or greater than) the maximum value, then the method 100 continues, at step 120, assigning the maximum value to the new position, at step 122, selecting a value for the speed adjustment that increases the speed of the drive unit, and, at step 124, assigning a new speed for the drive unit that includes the value for the speed adjustment. The method 100 can also include, at step 126, comparing the new speed to the maximum value for the speed of the drive unit. If the new speed is greater than (or equal to), then the method 100 can continue, at step 128, assigning the maximum value to the new speed. As also shown in FIG. 2, if the new position is less than the maximum value at step 118 or the new speed is less than the maximum speed at step 126, then the method 100 can continue, at step 110, to configure the compressor to operate at the value of the speed of the drive unit and the position of the inlet guide vane. At step 110, the method 100 may further include, at step 130, moving the inlet guide vane to the new position and, at step 132, operating the drive unit at the new speed.

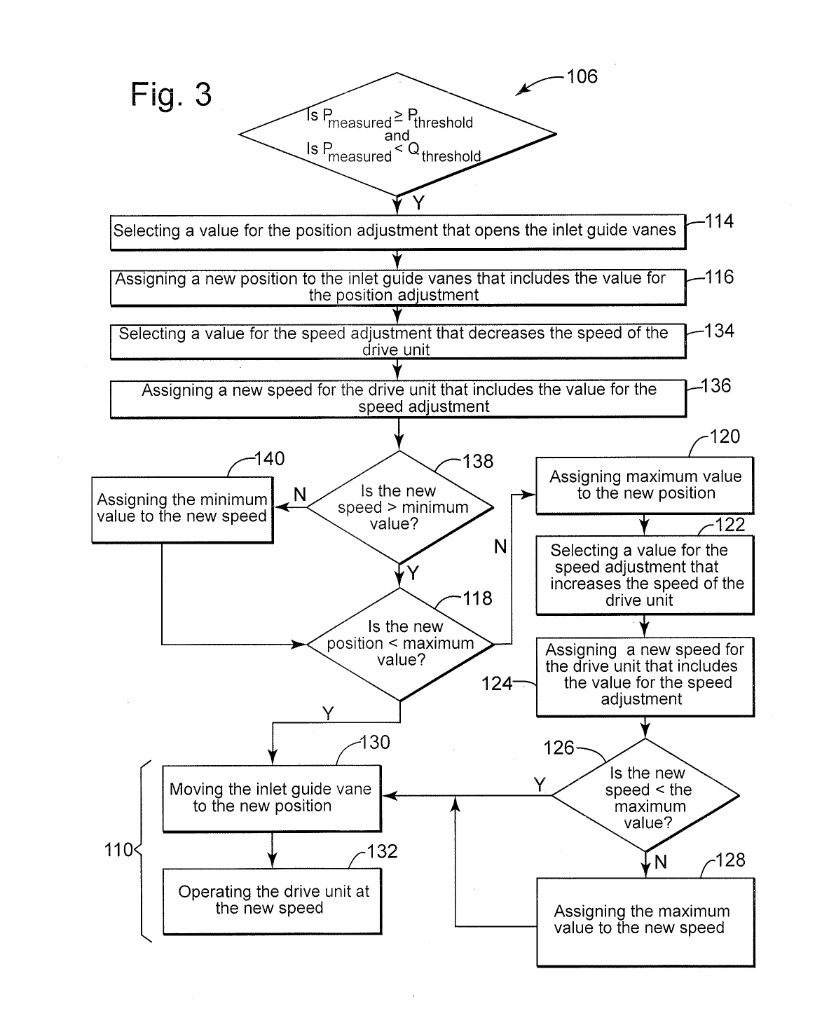

FIG. 3 shows steps for the method 100 that address the Operating Scenario 2 of Table 1. In this operating scenario, the measured value for the operating flow rate (Qₘ) is less than the threshold value (Qₜ) and the measured value for the operating pressure (Pₘ) is greater than or equal to the threshold value (Pₜ). The method 100 includes steps 114 and 116 to open the inlet guide vane to the new position. The method 100 also includes, at step 134, selecting a value for the speed adjustment that decreases the speed of the drive unit and, at step 136, assigning a new speed for the drive unit that includes the value for the speed adjustment. The method 100 also includes, at step 138, comparing the new speed to the minimum value for the speed of the drive unit. If the new speed is less than (or equal to) the minimum value, then the method 100 can include, at step 140, assigning the minimum value to the new speed. The method 100 can continue, at step 118, comparing the new position to the maximum value for the position of the inlet guide vane. If the new position is greater than (or equal to) the maximum value, then the method 100 continues, at step 120, assigning the maximum value to the new position, at step 122, selecting a value for the speed adjustment that increases the speed of the drive unit, and, at step 124, assigning a new speed for the drive unit that includes the value for the speed adjustment. The method 100 can also include, at step 126, comparing the new speed to the maximum value for the speed of the drive unit. If the new speed is greater than (or equal to), then the method 100 can continue, at step 128, assigning the maximum value to the new speed. As also shown in FIG. 3, if the new position is less than the maximum value at step 118 or the new speed is less than the maximum speed at step 126, then the method 100 can continue, at step 110, to configure the compressor to operate at the value of the speed of the drive unit and the position of the inlet guide vane. At step 110, the method 100 may further include, at step 130, moving the inlet guide vane to the new position and, at step 132, operating the drive unit at the new speed.

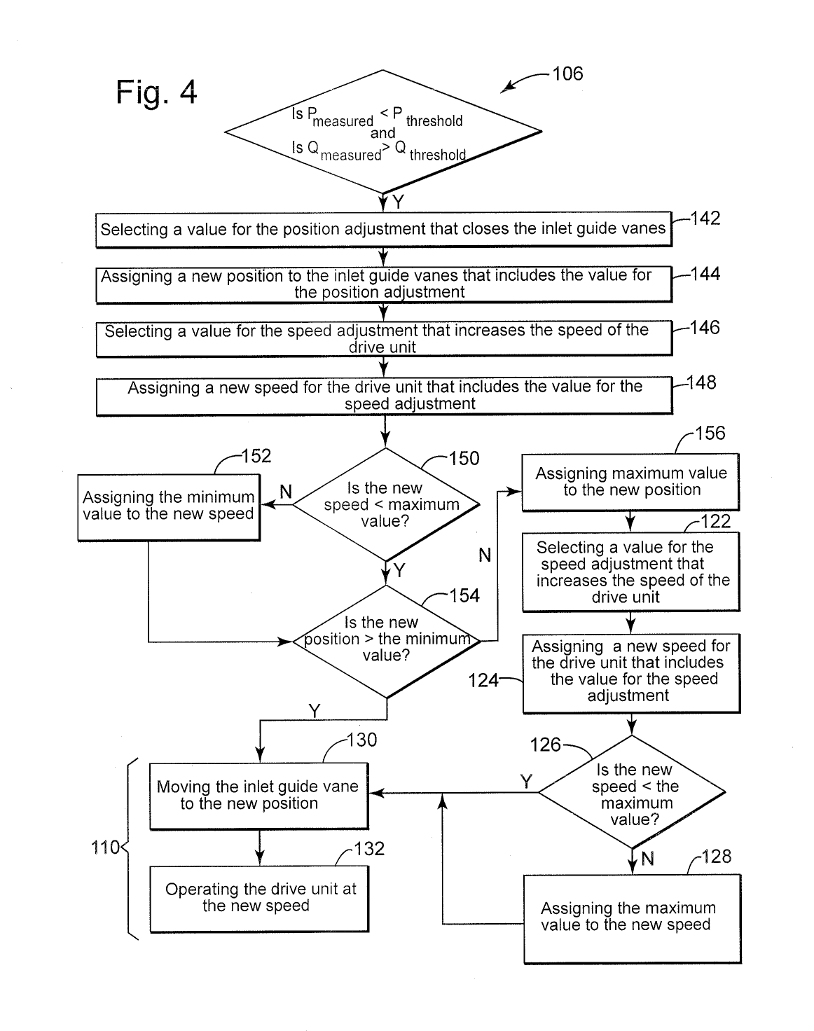

In the example of FIG. 4, the method 100 addresses the Operating Scenario 3 of Table 1. In this operating scenario, the measured value for the operating flow rate (Qₘ) is greater than the threshold value (Qₜ) and the measured value for the operating pressure (Pₘ) is less than the threshold value (Pₜ). The method 100 includes, at step 142, selecting a value for the position adjustment that closes the inlet guide vane and, at step 144, assigning a new position to the inlet guide vane that includes the value for the position adjustment. The method 100 also includes, at step 146, selecting a value for the speed adjustment that increases the speed of the drive unit and, at step 148, assigning a new speed for the drive unit that includes the value for the speed adjustment. In one embodiment, the method 100 includes, at step 150, comparing the new speed to the maximum value for the speed of the drive unit. If the new speed is greater than the maximum value, then the method 100 can include, at step 152, assigning the maximum value to the new speed. The method 100 can also include, at step 154, comparing the new position to the minimum value for the position of the inlet guide vane. If the new position is less than (or equal to) the minimum value, then the method 100 continues, at step 156, assigning the minimum value to the new position, at step 122, selecting a value for the speed adjustment that increases the speed of the drive unit, and, at step 124, assigning a new speed for the drive unit that includes the value for the speed adjustment. The method 100 can also include, at step 126, comparing the new speed to the maximum value for the speed of the drive unit. If the new speed is greater than (or equal to), then the method 100 can continue, at step 128, assigning the maximum value to the new speed. As also shown in FIG. 4, if the new position is less than the maximum value at step 118 or the new speed is less than the maximum speed at step 126, then the method 100 can continue, at step 110, to configure the compressor to operate at the value of the speed of the drive unit and the position of the inlet guide vane. At step 110, the method 100 may further include, at step 130, moving the inlet guide vane to the new position and, at step 132, operating the drive unit at the new speed.

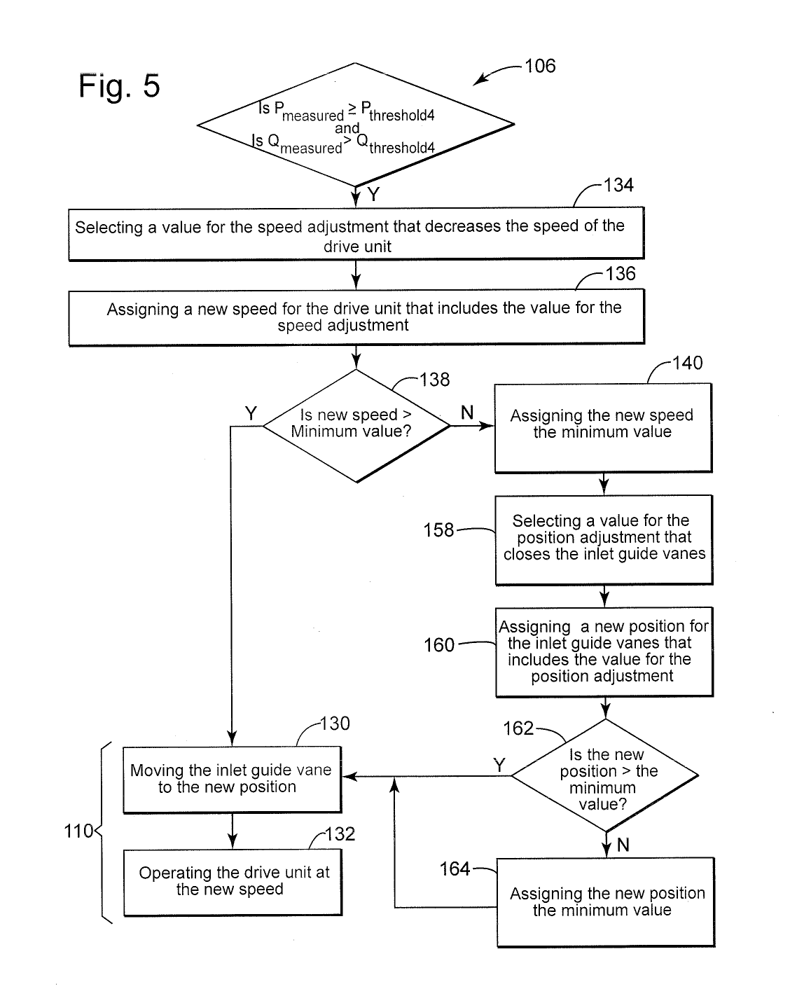

FIG. 5 shows steps for the method 100 that address the Operating Scenario 4 of Table 2. In this operating scenario, the measured value for the operating flow rate (Qₘ) is greater than the threshold value (Qₜ) and the measured value for the operating pressure (Pₘ) is greater than or equal to the threshold value (Pₜ). The method 100 includes, includes, at step 134, selecting a value for the speed adjustment that decreases the speed of the drive unit and, at step 136, assigning a new speed for the drive unit that includes the value for the speed adjustment. The method 100 also includes, at step 138, comparing the new speed to the minimum value for the speed of the drive unit. If the new speed is less than the minimum value, then the method 100 can include, at step 140, assigning the minimum value to the new speed. The method 100 can also include, at step 158, selecting a value for the position adjustment that closes the inlet guide vane and, at step 160, assigning a new position for the inlet guide vane that includes the value for the position adjustment. The method 100 also includes, at step 162, comparing the new position to the minimum value for the position of the guide vane. If the new position is less than (or equal to) the minimum position, then the method 100 continues, at step 164, assigning the minimum value to the new position. In one example in which the new position is greater than the minimum position, the method 100 can continue, at step 130, moving the inlet guide vane to the new position and, at step 132, operating the drive unit at the new speed.

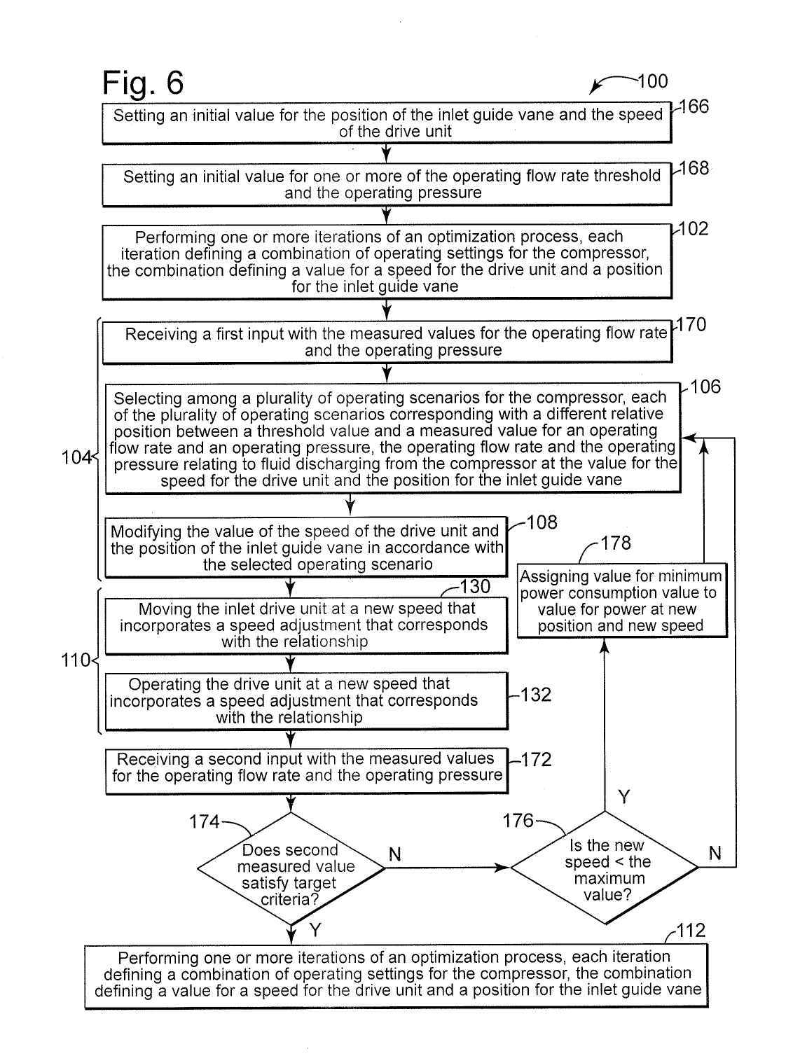

FIG. 6 illustrates a flow diagram for the method 100 that sets out additional details and steps that are useful for optimizing performance of the compressor. These steps may incorporate one or more of the steps described above in connection with FIGS. 2, 3, 4, and 5. In the embodiment of FIG. 6, the method 100 includes, at step 166, setting an initial value for the position of the inlet guide vane and the speed of the drive unit. The method 100 also includes, at step 168, setting an initial value for the threshold values for one or more of the operating flow rate and the operating pressure. The initial values for the position and speed may correspond to values that originate from the initial set-up and/or fit-up of the compressor as part of the process line. In conventional practice, these original values typically allow the compressor to achieve the setpoints without regard for power consumption. As noted herein, this disclosure offers an improvement over these conventional practices, in effect considering that the initial values may be less than and/or greater than these original values.

The method 100 can continue, at step 102, performing one or more iterations of the optimization process and more particularly, at step 170, receiving a first input with the measured values for the operating flow rate and the operating pressure. The method 100 further continues, at steps 106, 108, 110, 130, and 132, to utilize the various operating scenarios (e.g., Operating Scenarios 1, 2, 3, and 4 of Tables 1 and 2, and as show in the examples of FIGS. 2, 3, 4, and 5) to modify operation of the compressor. In one example, the method 100 can include, at step 172, receiving a second measured value for the operating flow rate and the operating pressure, wherein this second measured value can reflect the operating flow rate, the operating pressure, and a power consumption for the compressor at the new position and new speed (as described herein). The method 100 can also include, at step 174, comparing the second measured value to the setpoints for operating flow rate and operating pressure and to a minimum power consumption value. In one example, the minimum power consumption value corresponds with a previously-stored power consumption, typically a value for power consumption of the compressor at a previous speed for the drive unit and a previous position for the inlet guide vane. If the second measured value does not satisfy the one or more of the setpoints, then the method 100 can continue, at step 176, comparing the measured value for the power consumption to the previously-stored power consumption and where the measured value for the power consumption is less than the previously-stored power consumption, at step 178, assigning the measured value for the power consumption to the minimum power consumption value. The method 100 can then continue, at step 106, to continue to iterate through the optimization process until, for example, the method 100 continues, at step 112, completing the one or more iterations, as noted herein.

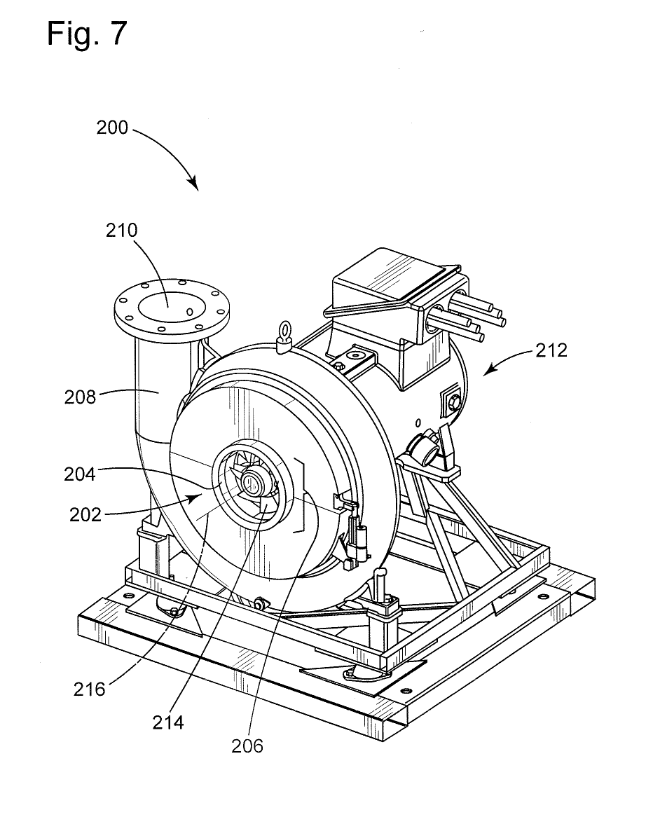

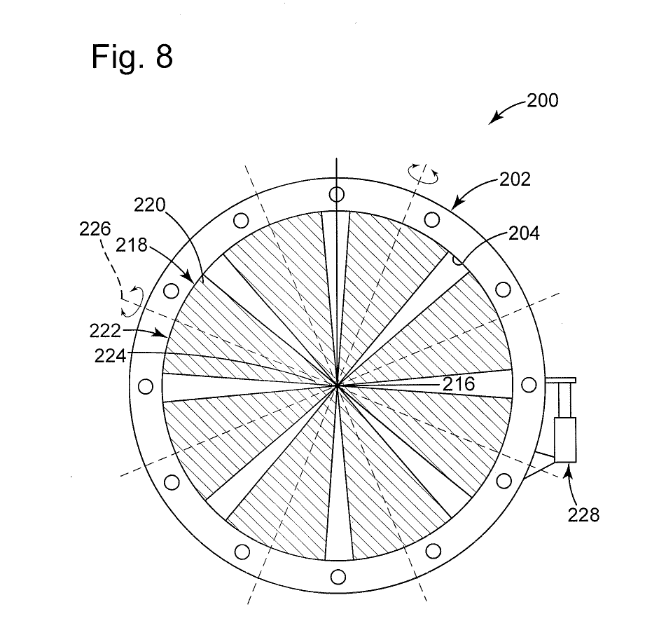

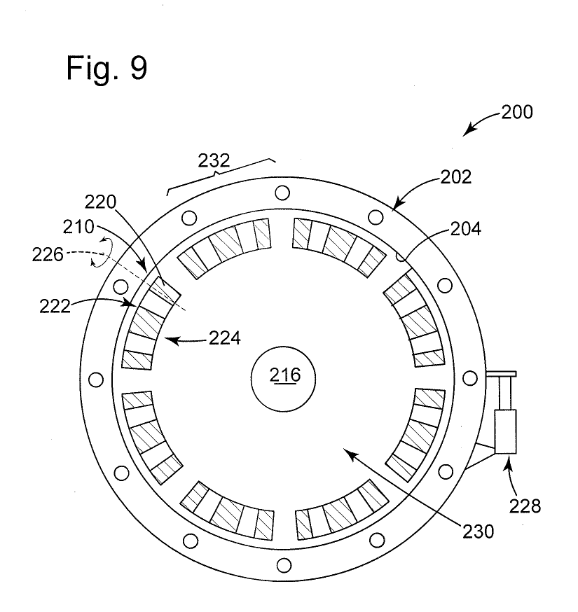

FIGS. 7, 8, and 9 depict in various views an example of a compressor in the form of a centrifugal compressor. Use of the compressor 200 is often associated with industrial processes as found in, for example, the automotive, electronics, aerospace, oil and gas, power generation, petrochemical, and like sectors and industries. FIG. 7 provides a perspective view of the compressor 200 (shown without inlet guide vanes at the inlet). FIG. 8 illustrates a front view of the compressor 200 with a first configuration for an inlet guide vane assembly. FIG. 9 depicts the front view of the compressor 200 with a second configuration for the inlet guide vane assembly.

In FIG. 7, the compressor 200 has an inlet 202 with an inner wall 204 that defines a flow area 206. The inner wall 204 can form part of a component commonly referred to as an inlet guide vane housing cover. The inlet 202 couples with a volute 208 that has an outlet 210 (also, “discharge 210”). Examples of the discharge 210 are configured to couple the compressor 200 with industrial piping, conduits, and like flow-related structures. As also shown in FIG. 7, the compressor 200 includes a drive unit 212 that couples with an impeller 214 having a central axis 216, typically through a gearbox and/or like assembly. In use, the drive unit 214 rotates the impeller 212 to draw a working fluid (e.g., air) into the inlet 202. The impeller 212 compresses the working fluid, which in turn flows through the volute 208 to form an exit flow that discharges from the compressor 200 at the discharge 210. This exit flow can exhibit one or more flow properties (e.g., flow rate, pressure, etc.) that meet certain desired setpoints on a process line. As the name implies, the inlet guide vane assembly may reside in and/or proximate the inlet 202 in a position that is upstream of the impeller 212 to regulate the effective size of the flow area 206, thus modulating the flow of working fluid into the compressor 200.

As noted above, FIGS. 8 and 9 show different configurations for the inlet guide vane assembly. The first configuration of FIG. 8 has a plurality of inlet guide vanes 218, each with a vane body 220 with a first end 222, a second end 224, and an axis 226 extending therebetween. In one implementation, the vane body 220 couples with the inner wall 204 at the first end 222 and with a component proximate the central axis 216 of the impeller 214. The compressor 200 can also include an actuator, identified generally by the numeral 228. In FIG. 9, the compressor 200 also includes a flow director 230 (also “bullet 230” or “insert 230”) that resides in the inlet 202. The bullet 230 segregates the flow area 206 (FIG. 7) into an annulus, which describes the area between the bullet 230 and the inner surface (or diameter) of the inlet guide vane housing cover. The inlet guide vanes 220 populate the annulus. Examples of the actuator can include cylinders and lead screw devices that couple with the vane body 220 in both configurations of FIGS. 8 and 9, typically via some intervening articulating structure. During operation, this intervening articulating structure can transfer movement of the actuator 228 to rotate the vane body 220 about the axis 226. This action changes the position of the vane body 220 to increase and decrease the effective size of the flow area 206 (FIG. 7).

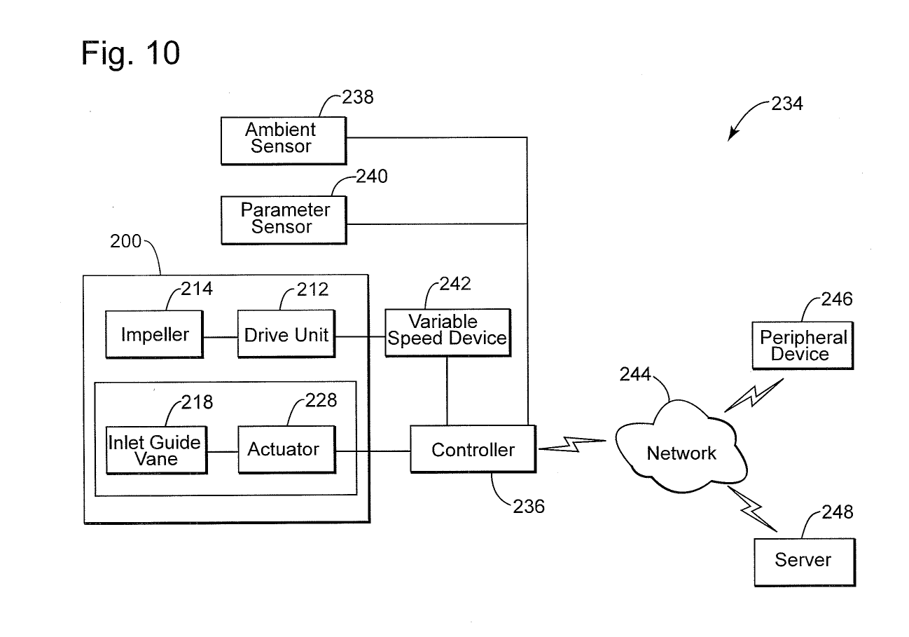

Referring also back to FIG. 6, the steps in the method 100 for receiving the input (e.g., at steps 170 and 172 of FIG. 6) can leverage configurations that provide feedback that quantifies the operation of the compressor. This feedback may arise internally at the compressor 200 (via, for example, one or more in-situ sensors) as well as in connection with use of a control system that manages operation of the compressor 200. To this end, FIG. 10 depicts a schematic view of an exemplary embodiment of a compressor 200. This embodiment is part of a control system 234 that includes a controller 236 that couples with an ambient sensor 238, an operating parameter sensor 240, and a variable speed drive 242. Examples of the variable speed drive 242 are configured to manage operation of the drive unit 212 to cause the impeller 214 to rotate at different speeds, e.g., from a first speed to a second speed. The controller 236 can also communicate with the actuator 228 to cause the inlet guide vanes 218 to change position, e.g., from a first position to a second position. In one embodiment, the controller 236 (or one or more other devices in the system 234) can communicate via a network 244 with a peripheral device 246 (e.g., a display, a computer, smartphone, laptop, tablet, etc.) and/or an external server 248.

The controller 236 includes computers and computing devices with processors and memory that can store and execute certain executable instructions, software programs, and the like. The controller 236 can be a separate unit, e.g., part of a control unit that operates the compressor 200 and other equipment. This control unit and/or the controller 236 can be located remote from the compressor 200, with communication between the compressor 200 and the controller 236 occurring by way of wireless and wired communication, e.g., via network 244. In other examples, the controller 236 integrates with the compressor 200, e.g., as part of the hardware and/or software that operates the drive unit 212 and/or the actuator 228.

The ambient sensor 238 provides information about the environment surrounding the compressor 200. This information can include ambient temperature, ambient pressure, and relative humidity, among other measurements. As set forth below, implementations of the system 234 can use this information to determine operation settings (e.g., positions for the inlet vane guides 218 and speed of the drive unit 212) for desired setpoints using these operating conditions and, in one particular example, correlating the setpoints for operating conditions during current operation with operating conditions that prevail during in-situ testing of the compressor 200.

The parameter sensor 240 monitors various conditions and parameters of the compressor 200. These parameters may include flow rate, flow velocity, static pressure, driver power, and the like. As noted above, these parameters often relate to the settings that dictate operation of the device. Examples of these settings include input power, current, voltage, and torque, among others. In one implementation, the settings identify the speed of the drive unit 212 and the position of the inlet guide vanes 218 (and/or some reasonable representation thereof). The parameter sensor 240 can comprise one or more sensor devices that are sensitive to the conditions and parameters. These sensor devices can embody flow meters, pressure transducers, accelerometers, and like components. Such devices generate signals (e.g., analog and digital signals), which include data that represents the measured value for the corresponding flow parameter.

Examples of the parameter sensor 240 may couple with a shaft or other mechanism that transfers energy from the drive unit 212 to the impeller 214. When in this position, the parameter sensor 240 can measure several parameters (e.g., torque, angular velocity, etc.) that define the operation of the drive unit 214 and/or the compressor 200 in general. Other positions for the parameter sensor 240 include proximate the interior of the volute (e.g., volute 208 of FIG. 7) and proximate the outlet (e.g., outlet 210 of FIG. 7), as well as other positions to measure flow parameters of the working fluid that moves through the compressor 200. In some embodiments, the system 234 may employ a flow meter at the inlet (e.g., inlet 202 of FIG. 7), a pressure sensor proximate the outlet (e.g., outlet 210 of FIG. 7), and/or circuitry to monitor the amount of power the drive unit 212 uses during operation of the compressor 200. The sensor devices provide signals to the controller 236. The compressor 200 may also include circuitry to operate the drive unit 212 that includes certain configurations of elements (e.g., capacitors, resistors, transistors, etc.) to monitor inputs to the drive unit 212, e.g., current, voltage, power, etc.

During one exemplary operation, movement of the actuator 228 can change the orientation of the inlet guide vane 218 with respect to the flow of the working fluid. This disclosure does, however, contemplate a wide range of configurations for the inlet guide vane 218. In one example the inlet guide vane 218 can rotate from one position (e.g., the first position) to another position (e.g., the second position), and vice versa. When found in an inlet guide vane assembly, collective rotation of the inlet guide vanes 218 by the actuator 228 changes the position of the inlet guide vanes 218 relative to one another to increase and decrease the flow area of the inlet (e.g., inlet 202 of FIG. 2).

One or more component of the 234 can transmit and/or encode data and information to define the operation of the compressor 200. The controller 236 can process the signals from the operation sensor 240 to generate the outputs. These outputs can encode instructions for operation of one or more components to configure the compressor 200. As set forth herein, the outputs can include data that relate to instructions to move the inlet guide vane 218, e.g., to instruct operation of the actuator 228 to change the orientation and/or position of the inlet guide vane 218. These instructions may, for example, cause the actuator 228 to move, which, in turn, moves (e.g., rotates) the inlet guide vane 218 through an angular offset from the first position to the second position. In one implementation, the outputs can include data that relate to instructions to operate the variable speed drive at a different speed.

In view of the foregoing, the embodiments herein implement an optimization process that can iterate through a multitude of combinations of operating settings on the compressor. This optimization process can identify at least one combination at which that lowers the power consumption, e.g., from the initial consumption that results during installation and/or fit-up with the process line. A technical effect of this embodiment is to provide the compressor and/or related control system with an effective tool to manage power consumption during real-time operation of the compressor.

One or more of the steps of the methods can be coded as one or more executable instructions (e.g., hardware, firmware, software, software programs, etc.). These executable instructions can be part of a computer-implemented method and/or program, which can be executed by a processor and/or processing device. The processor may be configured to execute these executable instructions, as well as to process inputs and to generate outputs, as set forth herein. For example, the software can run on the compressor, any related control device and/or diagnostics server, and/or as software, application, or other aggregation of executable instructions on a separate computer, tablet, laptop, smart phone, wearable device, and like computing device. These devices can display the user interface (also, a “graphical user interface”) that allows the end user to interact with the software to view and input information and data as contemplated herein.

The computing components (e.g., memory and processor) can embody hardware that incorporates with other hardware (e.g., circuitry) to form a unitary and/or monolithic unit devised to execute computer programs and/or executable instructions (e.g., in the form of firmware and software). Exemplary circuits of this type include discrete elements such as resistors, transistors, diodes, switches, and capacitors. Examples of a processor include microprocessors and other logic devices such as field programmable gate arrays (“FPGAs”) and application specific integrated circuits (“ASICs”). Memory includes volatile and non-volatile memory and can store executable instructions in the form of and/or including software (or firmware) instructions and configuration settings. Although all of the discrete elements, circuits, and devices function individually in a manner that is generally understood by those artisans that have ordinary skill in the electrical and software arts, it is their combination and integration into functional analog and/or digital and/or electrical groups and circuits that generally provide for the concepts that are disclosed and described herein.

Aspects of the present disclosure may be embodied as a system, method, or computer program product. The embodiments may take the form of an entirely hardware embodiment, an entirely software embodiment (including firmware, software, etc.) or an embodiment combining software and hardware aspects that may all generally be referred to herein as a “circuit,” “module” or “system.” The computer program product may embody one or more non-transitory computer readable medium(s) having computer readable program code embodied thereon.

In one embodiment, this disclosure contemplates a non-transitory computer readable medium comprising executable instructions stored thereon. Broadly, these instructions can embody one or more of the steps of the method 100, and its variants and embodiments, as noted herein. In one example, the executable instruction can comprise instructions for performing one or more iterations of an optimization process, each iteration defining a combination of operating settings for the compressor, the combination defining a value for a speed for the drive unit and a position for the inlet guide vane, the optimization process comprising, selecting among a plurality of operating scenarios for the compressor, each of the plurality of operating scenarios corresponding with a different relative position between a threshold value and a measured value for an operating flow rate and an operating pressure, the operating flow rate and the operating pressure relating to fluid discharging from the compressor at the value for the speed for the drive unit and the position for the inlet guide vane; modifying the value of the speed of the drive unit and the position of the inlet guide vane in accordance with the selected operating scenario; configuring the compressor to operate at the value of the speed of the drive unit and the position of the inlet guide vane; and completing the one or more iterations of the optimization process in response to the compressor operating at a minimum power consumption value with the measured value for the operating flow rate and the operating pressure at a setpoint threshold for the compressor, wherein the plurality of operating scenarios maintain the value for the speed of the drive unit and the position of the inlet guide vane at or above a minimum value and at or below a maximum value for the speed of the drive unit and the position of the inlet guide vanes.

Computer program code for carrying out operations for aspects of the present invention may be written in any combination of one or more programming languages, including an object oriented programming language and conventional procedural programming languages. Program code embodied on a computer readable medium may be transmitted using any appropriate medium, including but not limited to wireless, wireline, optical fiber cable, RF, etc., or any suitable combination of the foregoing.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for optimizing performance of a compressor having an inlet guide vane and a drive unit that is configured to rotate an impeller:
performing one or more iterations of an optimization process, each iteration defining a combination of operating settings for the compressor, the combination defining a value for a speed for the drive unit and a position for the inlet guide vane, the optimization process comprising,
selecting among a plurality of operating scenarios for the compressor, each of the plurality of operating scenarios corresponding with a different relative position between a threshold value and a measured value for an operating flow rate and an operating pressure, the operating flow rate and the operating pressure relating to fluid discharging from the compressor at the value for the speed for the drive unit and the position for the inlet guide vane;
modifying the value of one or more of the speed of the drive unit and the position of the inlet guide vane in accordance with the selected operating scenario;
configuring the compressor to operate at the value of the speed of the drive unit and the position of the inlet guide vane; and
completing the one or more iterations of the optimization process in response to the compressor operating at a minimum power consumption value with the measured value for the operating flow rate and the operating pressure at a setpoint threshold for the compressor,
wherein the plurality of operating scenarios maintain the value for the speed of the drive unit and the position of the inlet guide vane at or above a minimum value and at or below a maximum value for the speed of the drive unit and the position of the inlet guide vanes.

2. The method of claim 1, wherein the optimization process comprises:
selecting a value for the position adjustment that opens the inlet guide vane;
assigning a new position to the inlet guide vane that includes the value for the position adjustment; and
comparing the new position to the maximum value for the position of the inlet guide vane,
wherein the optimization process assigns the maximum value to the new position in response to the new position exceeding the maximum value.

3. The method of claim 2, wherein the optimization process comprises:
selecting a value for the speed adjustment that increases the speed of the drive unit;
assigning a new speed for the drive unit that includes the value for the speed adjustment;
comparing the new speed to the maximum value for the speed of the drive unit, and
wherein the optimization process assigns the maximum value to the new speed in response to the new speed exceeding the maximum value.

4. The method of claim 1, wherein the optimization process comprises:
selecting a value for the position adjustment that opens the inlet guide vane; and
selecting a value for the speed adjustment that decreases the speed of the drive unit.

5. The method of claim 4, wherein the optimization process comprises:
comparing the new speed to the minimum value, wherein the optimization process assigns the new speed the minimum value in response to the new speed having a value that is less than the minimum value.

6. The method of claim 4, wherein the optimization process comprises:
comparing the new position to the maximum value, wherein the optimization process assigns the new position the maximum value in response to the new position having a value that exceeds the maximum value.

7. The method of claim 6, wherein the optimization process comprises:
selecting a value for the speed adjustment that increases the speed of the drive unit;
assigning a new speed for the drive unit that includes the value for the speed adjustment;
comparing the new speed to the maximum value for the position of the inlet guide vane,
wherein the optimization process assigns the maximum value to the new speed in response to the new speed exceeding the maximum value

8. The method of claim 1, wherein the optimization process comprises:
selecting a value for the position adjustment that closes the inlet guide vane; and
selecting a value for the speed adjustment that increases the speed of the drive unit.

9. The method of claim 8, wherein the optimization process comprises:
comparing the new speed to the maximum value, wherein the optimization process assigns the new speed the maximum value in response to the new speed having a value that is less than the minimum value.

10. The method of claim 8, wherein the optimization process comprises:
comparing the new position to the minimum value, wherein the optimization process assigns the new position the maximum value in response to the new position having a value that exceeds the maximum value.

11. The method of claim 10, wherein the optimization process comprises:
selecting a value for the speed adjustment that increases the speed of the drive unit;
assigning a new speed for the drive unit that includes the value for the speed adjustment;
comparing the new speed to the maximum value for the position of the inlet guide vane,
wherein the optimization process assigns the maximum value to the new speed in response to the new speed exceeding the maximum value

12. The method of claim 1, wherein the optimization process comprises:
selecting a value for the speed adjustment that decreases the speed of the drive unit
assigning a new speed to the drive unit that includes the value for the speed adjustment; and
comparing the new speed to the minimum value for the speed of the drive unit,
wherein the new speed assumes the minimum value in response to the new speed having a value that is less than the minimum value.

13. The method of claim 12, wherein the optimization process comprises:
selecting a value for the position adjustment that closes the inlet guide vane;
assigning a new position for the inlet guide vane that includes the value for the position adjustment;
comparing the new position to the minimum value for the position of the inlet guide vane, and
wherein the optimization process assigns the minimum value to the new speed in response to the new speed exceeding the maximum value.

14. A system, comprising:
a compressor having a drive unit, an impeller coupled to the drive unit, and an inlet guide vane assembly in flow connection with the impeller, the inlet guide vane assembly comprising an actuator and an inlet guide vane coupled with the actuator; and
a controller coupled with the compressor, the controller configured to execute one or more executable instructions, the executable instruction comprising instructions for:
performing one or more iterations of an optimization process, each iteration defining a combination of operating settings for the compressor, the combination defining a value for a speed for the drive unit and a position for the inlet guide vane, the optimization process comprising,
selecting among a plurality of operating scenarios for the compressor, each of the plurality of operating scenarios corresponding with a different relative position between a threshold value and a measured value for an operating flow rate and an operating pressure, the operating flow rate and the operating pressure relating to fluid discharging from the compressor at the value for the speed for the drive unit and the position for the inlet guide vane;
modifying the value of one or more of the speed of the drive unit and the position of the inlet guide vane in accordance with the selected operating scenario;
configuring the compressor to operate at the value of the speed of the drive unit and the position of the inlet guide vane; and
completing the one or more iterations of the optimization process in response to the compressor operating at a minimum power consumption value with the measured value for the operating flow rate and the operating pressure at a setpoint threshold for the compressor,
wherein the plurality of operating scenarios maintain the value for the speed of the drive unit and the position of the inlet guide vane at or above a minimum value and at or below a maximum value for the speed of the drive unit and the position of the inlet guide vanes.

15. The system of claim 14, wherein the executable instructions include instructions for the optimization process that comprise:
selecting a value for the position adjustment that opens the inlet guide vane;
assigning a new position to the inlet guide vane that includes the value for the position adjustment; and
comparing the new position to the maximum value for the position of the inlet guide vane,
wherein the optimization process assigns the maximum value to the new position in response to the new position exceeding the maximum value.

16. The system of claim 14, wherein the executable instructions include instructions for the optimization process that comprise:
selecting a value for the position adjustment that opens the inlet guide vane;
selecting a value for the speed adjustment that decreases the speed of the drive unit;
comparing the new speed to the minimum value, wherein the optimization process assigns the new speed the minimum value in response to the new speed having a value that is less than the minimum value;
comparing the new position to the maximum value, wherein the optimization process assigns the new position the maximum value in response to the new position having a value that exceeds the maximum value.

17. The system of claim 14, wherein the executable instructions include instructions for the optimization process that comprise:
selecting a value for the position adjustment that closes the inlet guide vane;
selecting a value for the speed adjustment that increases the speed of the drive unit;
comparing the new speed to the maximum value, wherein the optimization process assigns the new speed the maximum value in response to the new speed having a value that is less than the minimum value.
comparing the new position to the minimum value, wherein the optimization process assigns the new position the maximum value in response to the new position having a value that exceeds the maximum value.

18. A controller, comprising:
a processor,
memory coupled with the processor; and
executable instructions stored on the memory and configured to be executed by the processor, the executable instruction for,
performing one or more iterations of an optimization process, each iteration defining a combination of operating settings for the compressor, the combination defining a value for a speed for the drive unit and a position for the inlet guide vane, the optimization process comprising,
selecting among a plurality of operating scenarios for the compressor, each of the plurality of operating scenarios corresponding with a different relative position between a threshold value and a measured value for an operating flow rate and an operating pressure, the operating flow rate and the operating pressure relating to fluid discharging from the compressor at the value for the speed for the drive unit and the position for the inlet guide vane;
modifying the value of one or more of the speed for the drive unit and the position for the inlet guide vane in accordance with the selected operating scenario; and
configuring the compressor to operate at the value of the speed of the drive unit and the position of the inlet guide vane; and
completing the one or more iterations of the optimization process in response the compressor operating at a minimum power consumption value with the measured value for the operating flow rate and the operating pressure at a setpoint threshold for the compressor,
wherein the plurality of operating scenarios maintain the value for the speed of the drive unit and the position of the inlet guide vane at or above a minimum value and at or below a maximum value for the speed of the drive unit and the position of the inlet guide vanes.

19. The controller of claim 18, wherein executable instructions include instructions for the optimization process that comprise:
selecting a value for the position adjustment that opens the inlet guide vane;
assigning a new position to the inlet guide vane that includes the value for the position adjustment; and
comparing the new position to the maximum value for the position of the inlet guide vane,
wherein the optimization process assigns the the maximum value to the new position in response to the new position exceeding the maximum value.

20. The controller of claim 18, wherein executable instructions include instructions for the optimization process that comprise:
selecting a value for the position adjustment that opens the inlet guide vane;
selecting a value for the speed adjustment that decreases the speed of the drive unit;
comparing the new speed to the minimum value, wherein the optimization process assigns the new speed the minimum value in response to the new speed having a value that is less than the minimum value;
comparing the new position to the maximum value, wherein the optimization process assigns the new position the maximum value in response to the new position having a value that exceeds the maximum value.
